(19) United States
(12) Patent Application Publication
(10) Pub. No.: US 2026/0243554 A1
(43) Pub. Date: Aug. 20, 2026

(54) TAPE MEASURE AND HOOK

(71) Applicant: KOMELON CORPORATION, Busan (KR)

(72) Inventors: Dong Hun KANG, Busan (KR); Nam Hoon KANG, Busan (KR)

(21) Appl. No.: 18/871,131

(22) PCT Filed: Jun. 1, 2023
(86) PCT No.: PCT/IB2023/055644

§ 371 Date: Dec. 2, 2024

(30) Foreign Application Priority Data
Jun. 3, 2022 (KR) 10-2022-0068497

(51) Int. Cl. G01B 3/1056; G01B 3/1005; G01B 3/1041

(52) U.S. Cl. CPC G01B 3/1056; G01B 3/1005; G01B 3/1041; G01B 2003/103

(57) ABSTRACT

A tape measure includes a blade and a hook fixed at an end of the blade, wherein the hook includes a hook part, an upper fixing plate provided on a top of the end of the blade, a lower fixing plate provided on a bottom of the end of the blade while facing the upper fixing plate, and fastening parts fastening the fixing plate, the blade, and the lower fixing plate, and protection protrusions protruding around the fastening parts may be formed on the lower fixing plate.

### TECHNICAL FIELD

The present disclosure relates to a hook of a tape measure and, in more detail, to a hook and a tape measure that make it possible to advantageously design the number, material, and arrangement of fastening structures such as a rivet by improving fastening structures such as a rivet.

### BACKGROUND ART

Existing tape measures include a housing, a bobbin, a blade wound on the outer surface of the bobbin, a spring for restoring the bobbin or the blade, and a hook mounted at the end of the blade. The hook of the components is mounted to be slidable within a limited range at the end of the blade and can allow the end of the blade to be easily fixed or accurately supported at desired positions. The hook can also allow repeated reuse of the tape measure by preventing the blade from being hidden inside the inlet of the housing.

To this end, hooks may be fixed at the end of a blade generally using fastening structures such as a rivet and may be provided in two or more to guide sliding of a blade in the longitudinal direction.

A tape measure has been disclosed in U.S. Patent Application Publication No. 2010/0175273. The tape measure includes a hook at the end, the hook includes an attachment portion at the upper portion, a hook portion perpendicularly extending from the end of the attachment portion, and a plurality of slits formed at the attachment portion, and the attachment portion is fastened to the end of a blade using rivets, etc.

The rivets fastening the hook to the blade frequently hit against the outside. Accordingly, the rivet portions are frequently damaged in comparison to other parts, so if even one of the rivets is damaged, so the entire tape measure cannot perform its full function, so users may need to purchase a new tape measure.

FIG. 1 is a view illustrating arrangement of rivets on a hook in the related art and FIG. 2 is a view illustrating the case when rivets hit of a hook of the related art hit against the outside.

Referring to FIG. 1, there may be various methods for protecting rivets coupling a hook to a blade.

For example, as in (a), four rivets 10 may be arranged in a cross shape. In this case, even though one of the rivets is lost or damaged, the other rivets 10 can protect the fastened state. However, there is a problem that the number of processes increases and it is difficult to achieve a small size because it is required to arrange and fix four rivets 10 on a narrow blade.

Further, when the hook is returned to the initial position after the tape measure is used, the hook applies considerable shock by hitting against the housing, so it may be a problem to increase the weight of the hook because the heavier the hook, the greater the shock that a user has to endure.

Referring to (b), there is also a structure in which three rivets 10 are arranged in a zigzag pattern and the front two are fixed offset to the left and right to narrow the portion that is worn. The rivets are asymmetrically disposed in terms of the external appearance and three rivets 10 should be disposed, which also causes a problem that manufacturing is difficult and it is disadvantageous in small-sizing.

Referring to (c), a relatively small number of rivets 10 are disposed in series, so there is an advantage that manufacturing is easy and it is advantageous in small-sizing. However, continuous friction is intensively generated at the small number of rivets 10, and even if even any one of the rivets 10 is damaged, the normal function of the hook may be interfered with.

Referring to FIG. 2, rivets 10 exposed downward may often get caught or hit against the surrounding environment as indicated by arrows when a hook 20 is fixed to a target or is returned to the initial position after measuring the length. The rivets 10 may be easily damaged or broken due to repetition of this situation.

Further, when the hook 20 is diagonally approached to a target, the rivets 10 may obstruct smooth measurement by being directly caught to the outside. It may be possible to make the lower portions of the rivets 10 thin in order to prevent this situation, but when a rivet is made thin, the durability of the rivet is deteriorated, so this cannot be a fundamental solution.

### DISCLOSURE

### Technical Problem

The present disclosure provides a tape measure and a hook that can increase the durability and lifespan of a tape measure by effectively protecting fastening structures such as a rivet on the hook of the tape measure.

The present disclosure provides a tape measure and a hook that can prevent catching at regions other than a hook part by forming a protection jaw around a structure that fastens the hook to the tape measure.

The present disclosure provides a tape measure and a hook that make it possible to form a fastening structure for fixing a hook more firmly in a sufficient size by solving the problem of catching.

### Technical Solution

According to an exemplary embodiment of the present disclosure, a tape measure includes a blade and a hook fixed at an end of the blade, wherein the hook includes a hook part, an upper fixing plate provided on a top of the end of the blade, a lower fixing plate provided on a bottom of the end of the blade while facing the upper fixing plate, and fastening parts fastening the upper fixing plate, the blade, and the lower fixing plate, and at least one protection protrusion protruding around the fastening parts may be formed on the lower fixing plate.

The fastening part may form a fastening structure such as a rivet and may form a structure protruding downward from the bottom of the lower fixing plate. A structure of the fastening part protruding upward from the upper fixing plate is formed on a concave surface of the blade, so it does not matter, but the structure protruding downward is formed on a convex surface of the blade, so it is bound to have frequent collision with the outside.

Accordingly, the lower fixing plate is additionally formed and at least one protection protrusion is formed around the structure of the fastening part protruding downward on the lower fixing plate, so it is possible to prevent or reduce collision between the fastening part and the outside.

In the specification, the tape measure is provided in a structure including a blade and a hook and other structures may include a closed-type housing or an open-type housing and may include or may not include a spring or a motor for automatically returning the blade.

The protection protrusions may be formed ahead of or behind a lower protrusion of the fastening part and may be formed with a height that is at least the same as or larger than the height of the lower protrusion of the fastening part, but even though they are shorter than the lower protrusion, they can prevent excessive collision.

The protection protrusions may be formed at the left and right of a lower protrusion of the fastening part. The protection protrusions formed at the left and right can protect the fastening parts, respectively, but they may be formed in a 11-shape at the left and right to simultaneously protect two or more fastening parts. The protection protrusions formed at the left and right may be formed in straight line shapes like a 11-shape, but may be formed in arc shapes.

Further, one of the protection protrusions may be formed at a lower portion of the end of the blade to be directly adjacent to the hook. When the hook is diagonally approached to a position where the hook is supposed to get caught, a protection protrusion directly adjacent to the hook part comes in contact with the target position earlier than the fastening part, so it can protect the fastening part.

In particular, since the fastening part is protected by the protection protrusions, it is possible to increase the durability of a rivet structure that is relatively vulnerable to shock, but is advantageous in terms of manufacturing cost and downsizing. For example, it ma be possible to form at least two rivets in a line by forming protection protrusions on the lower fixing plate around fastening parts formed in a line along the center of the blade.

The hook part may be integrally connected to the upper fixing plate, but the present disclosure is not limited thereto and may include the case when the hook part is integrally connected to the lower fixing plate.

According to an exemplary embodiment of the present disclosure, a hook fixed to the end of a blade of a tape measure for measuring a length may include a hook part, an upper fixing plate provided on a top of the end of the blade, a lower fixing plate provided on a bottom of the end of the blade while facing the upper fixing plate, and fastening parts fastening the fixing plate, the blade, and the lower fixing plate, and protection protrusions protruding around the fastening parts may be formed on the lower fixing plate.

The protection protrusions may be formed ahead of or behind a lower protrusion of the fastening part, may be formed at the left and right of the lower protrusion of the fastening part, and may be provided in a combination thereof.

### Advantageous Effects

The tape measure and the hook of the present disclosure effectively protect fastening parts such as a rivet, so it is possible to increase the durability and lifespan of a tape measure and prevent unexpected catching due to protruding structures other than the hook part.

Further, the problem of catching is solved in the tape measure and the hook of the present disclosure, it is possible to form a fastening structure for fixing the hook more firmly in an appropriate size or using an appropriate material, and, in this process, it is also possible to use cheaper and safer parts.

### BRIEF DESCRIPTION OF THE DRAWINGS

FIG. 1 is a view illustrating arrangement of a rivet on a hook of the related art;

FIG. 2 is a view illustrating the case when rivets on a hook of the related art collide with the outside;

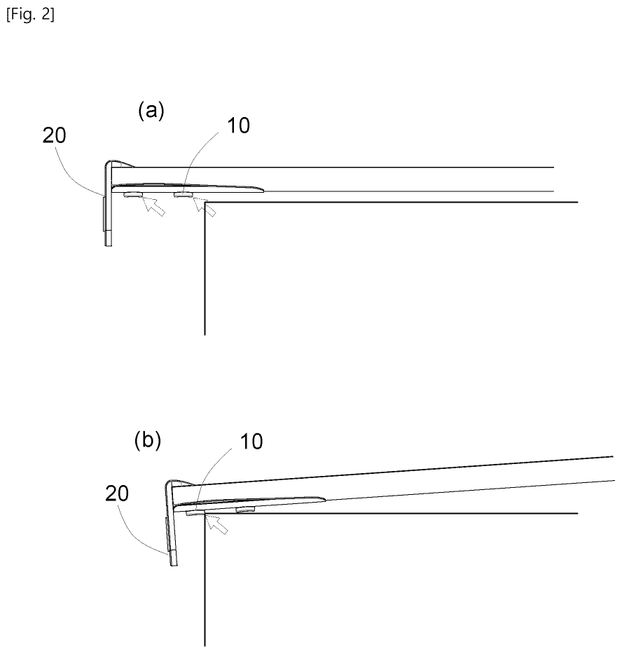

FIG. 3 is a view illustrating a tape measure and a hook according to an embodiment of the present disclosure;

FIG. 4 is a view illustrating the structure of the hook of FIG. 3;

FIG. 5 is a view illustrating the coupling relationship of the hook of FIG. 3;

FIG. 6 is a view illustrating the operation mechanism of the hook of FIG. 3;

FIG. 7 is a view illustrating the structure of a hook according to an embodiment of the present disclosure;

FIG. 8 is a view illustrating the coupling relationship of the hook of FIG. 7;

FIG. 9 is a view illustrating the structure of a hook according to an embodiment of the present disclosure;

FIG. 10 is a view illustrating the coupling relationship of the hook of FIG. 9;

FIG. 11 is a view illustrating the structure of a hook according to an embodiment of the present disclosure; and

FIG. 12 is a view illustrating the coupling relationship of the hook of FIG. 11.

### MODE FOR INVENTION

Preferred embodiments of the present disclosure will be described in detail with reference to the accompanying drawings, but the present disclosure is not limited or restricted to the embodiments. For reference, the same reference numerals substantially indicate the same components in the description, it is possible to refer to the matters shown in other figures under this rule, and matters that are determined as being apparent or repetitive to those skilled in the art may be omitted.

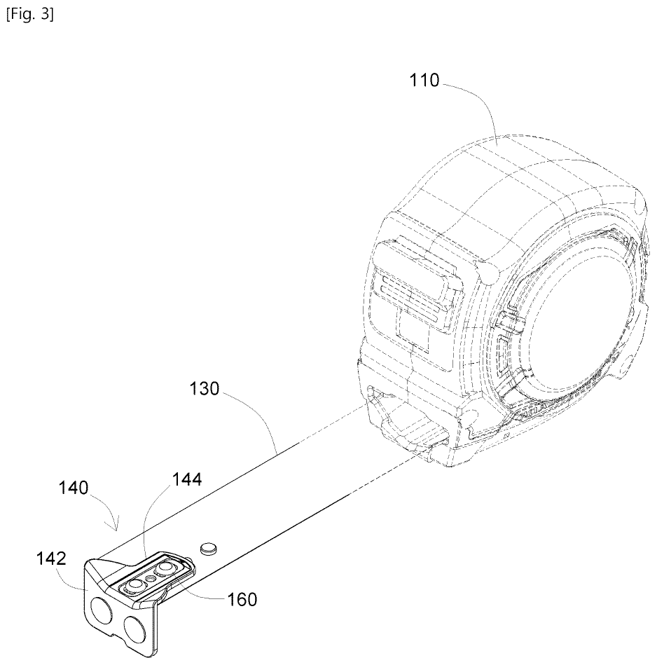

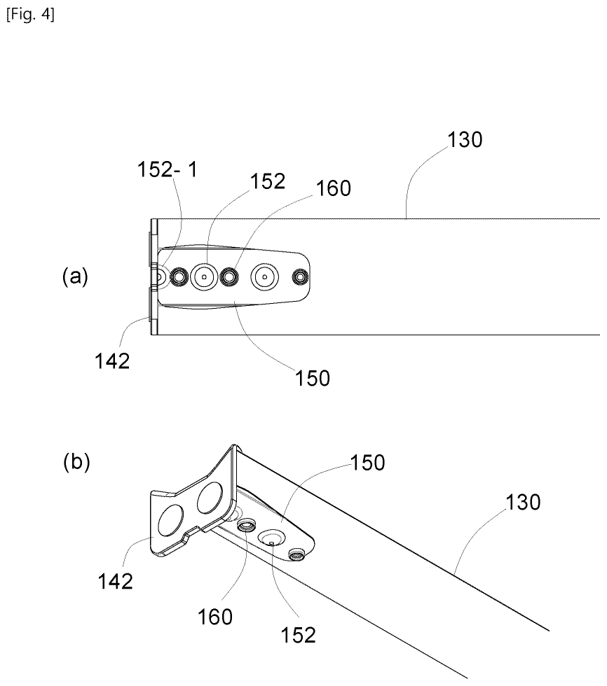

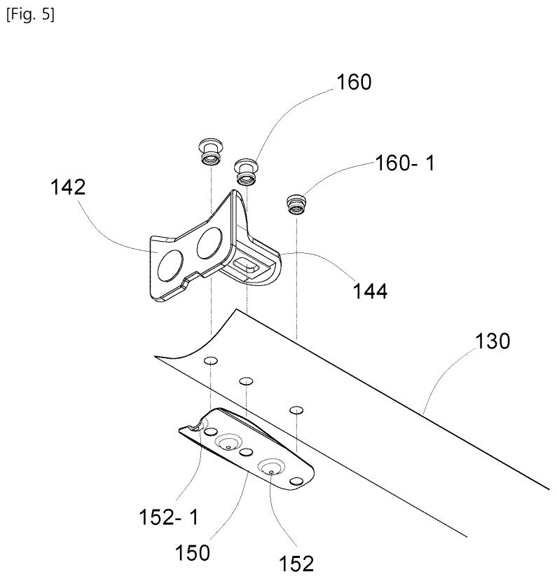

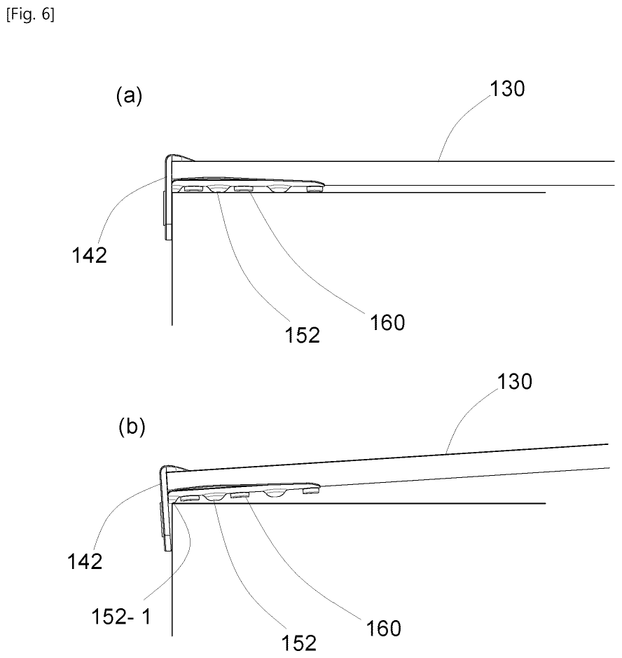

FIG. 3 is a view illustrating a tape measure and a hook according to an embodiment of the present disclosure, FIG. 4 is a view illustrating the structure of the hook of FIG. 3, FIG. 5 is a view illustrating the coupling relationship of the hook of FIG. 3, and FIG. 6 is a view illustrating the operation mechanism of the hook of FIG. 3.

Referring to FIG. 3 to FIG. 6, a spring control tape measure according to this embodiment may include a housing 110, a bobbin provide in the housing 110, a blade 130 wound on the outer surface of the bobbin and being drawn out of the housing 110 to measure a length, and a spring for returning the blade into the housing 110.

A hook 140 may be mounted at the end of the blade 130 and can fix the end of the blade 130 at specific positions or can prevent the entire blade 130 from being hidden in the housing 110.

The hook 140 may include a hook part 143, an upper fixing plate 140, a lower fixing late 150, and a fastening part 160 of a rivet structure. The hook part 142 and the upper fixing plate 144 are integrally formed and can form an L-shape, and a slit extending in the longitudinal direction of the blade 130 may be formed at the upper fixing plate 144 to allow sliding movement of the fastening part 160. Accordingly, the hook part 142 and the upper fixing plate 144 can be moved within a distance allowed by the slit at the end of the blade 130 while they are fixed at the fastening part 160.

The hook part 142 and the upper fixing plate 144 are integrally formed in this embodiment, but, in another embodiment, the hook part and the lower fixing plate may be integrally formed, and, in this case, the slit described above and a protection protrusion to be described below may be both formed at the lower fixing plate.

The lower fixing plate 150 may be in contact with the end of the blade 130 with respect to the upper fixing plate 144 and may be fixed to the upper fixing plate 144 and the blade 130 by the fastening part. Further, protection protrusions 152 protruding ahead of and behind the fastening part 160 may be formed at the lower fixing plate 150.

The protection protrusions 152 may be formed ahead of and behind a lower protruding portion of the fastening part 160 protruding downward from the lower fixing plate 150 and may be formed like a hill, as shown in the figures, but may be formed in various shapes.

Further, the protection protrusions 152 may protrude with a height that is the same as or larger than the height of the lower protruding portion of the fastening part 160. However, even though the protection protrusions are shorter than the lower protruding portion of the fastening part, they can prevent excessive collision.

The fastening part 160 employs a rivet structure in this embodiment, but other similar fasteners or fastening structures may be used. Further, the same parts may be used for the fastening part, but, as shown in the figures, the innermost fastening part 160-1 is fastened only to the blade 130 and the lower fixing plate 150, so other kinds of rivets may be used.

In this case, rivets that substantially fasten the upper fixing plate 144 may be two fastening parts 160, and lower protruding portions of the fastening parts 160 can be protected forward and rearward by the protection protrusions 152.

Referring to FIG. 6, the protection protrusions 152 are formed ahead of and behind the fastening part 160 on the lower fixing plate 150, so it is possible to minimize contact of the fastening part 160 with the outside and the height of the protection protrusions 152 may be larger than the height of the lower protrusion of the fastening part 160 (a).

Further, one 152-1 of the protection protrusions 152 may be formed at the lower portion of the end of the blade 130 to be directly adjacent to the hook part 142. The protection protrusion 152-1 can protect the fastening part 160 by coming in contact a target position earlier than the fastening part 160 when the hook part 142 is diagonally approached to a position where the hook part 142 is supposed to get caught (b).

For reference, the tape measure includes the close-type housing 110 and is automatically returned by the spring therein in this embodiment, but, in other embodiments, the tape measure may be provided without the housing and an open-type housing may be provided.

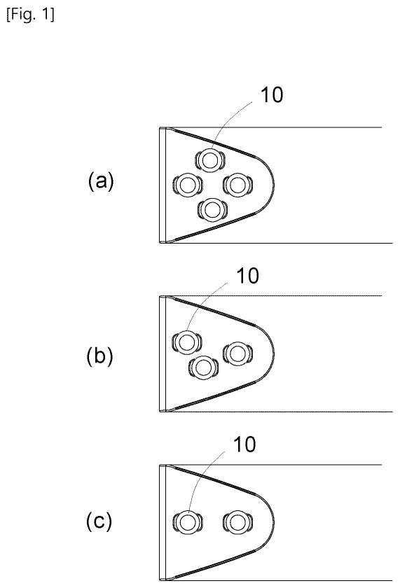

Even though the fastening parts 160 are provided in a line along the center of the blade 130, they can be sufficiently protected from external shock and at least two fastening parts 160 may also be formed. Accordingly, as shown in FIG. 1, durability can be sufficiently ensured by at least two fastening parts even though four fastening parts such as rivets are disposed in a cross shape or three fastening parts may be disposed in a zigzag pattern. Further, manufacturing is possible even by at least two rivet, so it is possible to make a small-sized hook and reduce the weight at the end. The fact that a small and light hook can be manufactured may mean that it is possible to reduce shock that is transmitted to the user's hand when the hook hits against the inlet of the housing while the hook is returned.

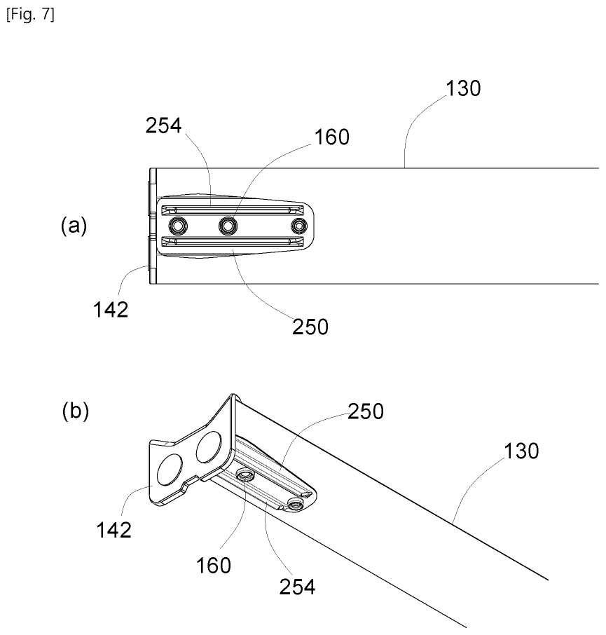

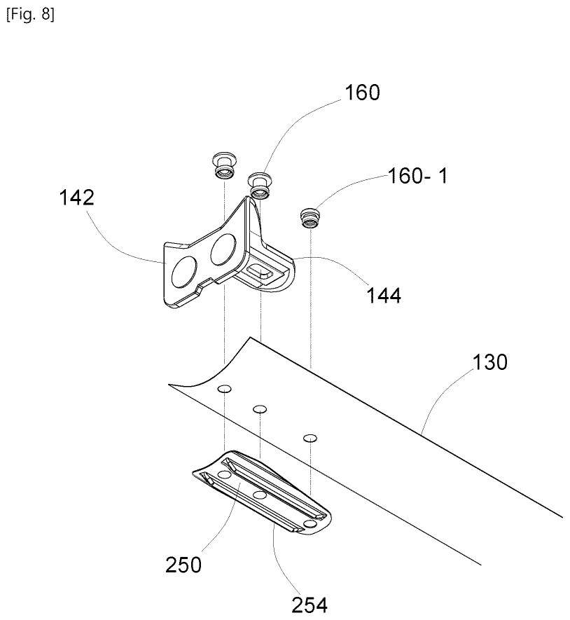

FIG. 7 is a view illustrating the structure of a hook according to an embodiment of the present disclosure and FIG. 8 is a view illustrating the coupling relationship of the hook of FIG. 7.

Referring to FIG. 7 and FIG. 8, a hook using another lower fixing plate 250 may be applied to the end of the blade 130. The hook may include a hook part 142, an upper fixing plate 144, and a fastening part 160 of a rivet structure in the same or similar structure and the above description may be referred to for these components.

The lower fixing plate 250 may include protection protrusions 254 protruding at the left and right of the fastening part 160. The protection protrusions 254 are formed in a 11-shape and may be formed with a length that can protect the entire fastening part 160 protruding from the lower fixing plate 250.

The protection protrusions 254 may protrude with a height the same as or larger than the height of the lower protrusion of the fastening part 160, but even though they are shorter than the lower protrusion of the fastening part, they can prevent excessive collision.

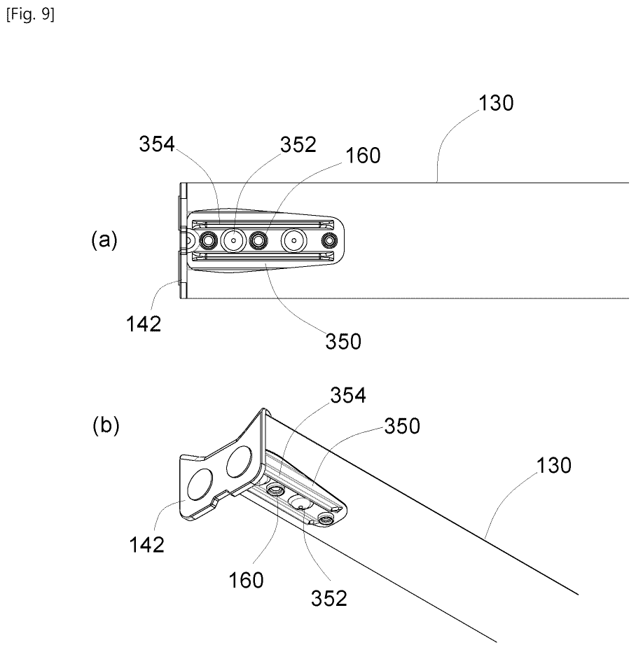

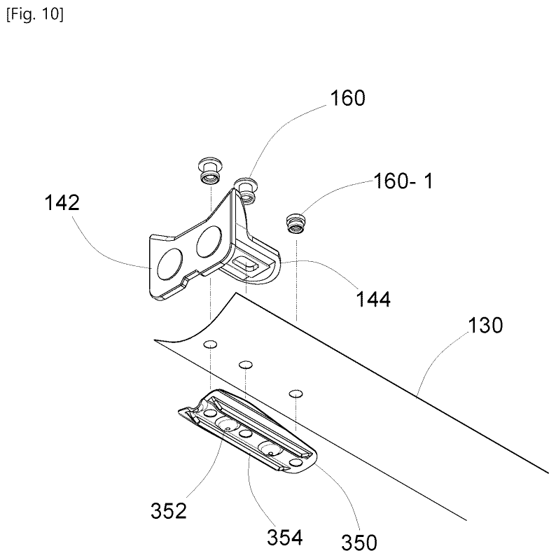

FIG. 9 is a view illustrating the structure of a hook according to an embodiment of the present disclosure and FIG. 10 is a view illustrating the coupling relationship of the hook of FIG. 9.

Referring to FIG. 9 and FIG. 10, a hook using another lower fixing plate 350 may be applied to the end of the blade 130. The hook may include a hook part 142, an upper fixing plate 144, and a fastening part 160 of a rivet structure in the same or similar structure and the above description may be referred to for these components.

The lower fixing plate 350 may include protection protrusions 352 and 354 protruding ahead of and behind, and at the left and right of the fastening part 160. This is a combination of the protection protrusions described above, hill-shaped protection protrusions 352 may be formed ahead of and behind the fastening part 160 and the 11-shaped protection protrusions 354 may be formed at the left and right of the fastening part 160.

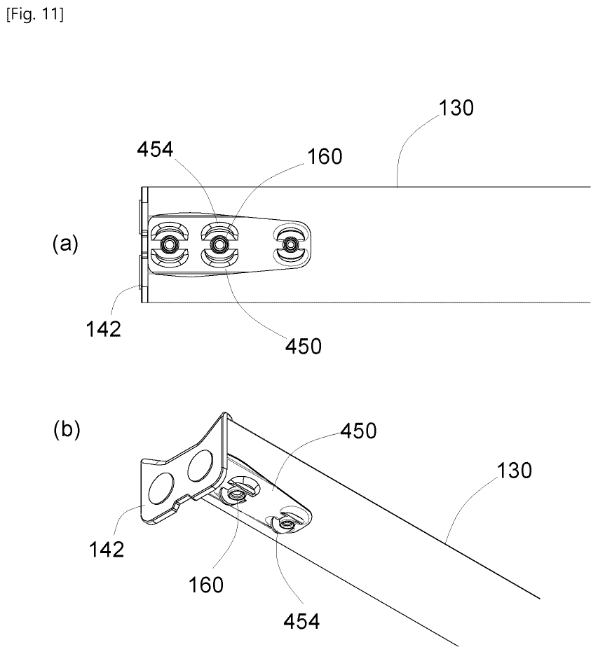

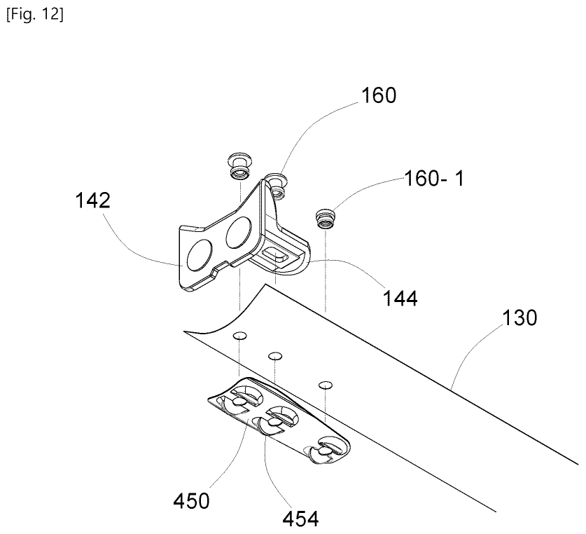

FIG. 11 is a view illustrating the structure of a hook according to an embodiment of the present disclosure and FIG. 12 is a view illustrating the coupling relationship of the hook of FIG. 11.

Referring to FIG. 11 and FIG. 12, a hook using another lower fixing plate 450 may be applied to the end of the blade 130. The hook may include a hook part 142, an upper fixing plate 144, and a fastening part 160 of a rivet structure in the same or similar structure and the above description may be referred to for these components.

The lower fixing plate 450 may include protection protrusions 454 protruding in arc shapes at the left and right of each fastening part 160. The protection protrusions are formed in a dune shape at the left and right, so they can protect not only the left and right, but the front and rear of the fastening part 160. Further, O-shaped or C-shaped protection protrusions may also be formed.

Although exemplary embodiments of the present disclosure were described above with reference to the drawings, it should be understood that the present disclosure may be changed and modified in various ways by those skilled in the art without departing from the spirit and scope of the present disclosure described in claims.

1. A tape measure comprising a blade and a hook fixed at an end of the blade,
wherein the hook includes a hook part, an upper fixing plate provided on a top of the end of the blade, a lower fixing plate provided on a bottom of the end of the blade while facing the upper fixing plate, and fastening parts fastening the upper fixing plate, the blade, and the lower fixing plate; and
a protection protrusion protruding around the fastening parts is formed on the lower fixing plate.

2. The tape measure of claim 1, wherein the protection protrusion is formed ahead of or behind a lower protrusion of the fastening part.

3. The tape measure of claim 1, wherein the protection protrusion is formed at the left and right of a lower protrusion of the fastening part.

4. The tape measure of claim 2, wherein the protection protrusion is formed in a 11-shape at the left and right of the lower protrusion.

5. The tape measure of claim 2, wherein the protection protrusion is formed in arc shapes at the left and right of the lower protrusion.

6. The tape measure of claim 1, wherein the protection protrusion is formed at a lower portion of the end of the blade to be adjacent to the hook part.

7. The tape measure of claim 1, wherein the fastening parts are formed in a line along a center of the blade.

8. The tape measure of claim 1, wherein the hook part is integrally formed with the upper fixing plate or the lower fixing plate.

9. A hook fixed at an end of a blade of a tape measure for measuring a length, the hook comprising:
a hook part, an upper fixing plate provided on a top of the end of the blade, a lower fixing plate provided on a bottom of the end of the blade while facing the upper fixing plate, and fastening parts fastening the fixing plate, the blade, and the lower fixing plate,
wherein protection protrusions protruding around the fastening parts are formed on the lower fixing plate.

10. The hook of claim 9, wherein the protection protrusion is formed ahead of or behind a lower protrusion of the fastening part.

11. The hook of claim 9, wherein the protection protrusion is formed at the left and right of a lower protrusion of the fastening part.
